(19) United States
(12) Patent Application Publication
(10) Pub. No.: US 2007/0266403 A1
(43) Pub. Date: Nov. 15, 2007

(54) System and method for personalized video program listing and targeted content advertisement

(75) Inventors: Canhui Ou, Danville, CA (US); Zhi Li, Austin, TX (US); Steven Gemelos, Cupertino, CA (US); Steve Sposato, Lafayette, CA (US); Raghvendra G. Savoor, Walnut Creek, CA (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/434,986

(22) Filed: May 15, 2006

(51) Int. Cl. H04N 5/445; H04N 7/10; H04N 7/025; G06F 13/00

(52) U.S. Cl. 725/46; 725/45; 725/34; 725/35

(57) ABSTRACT

Various embodiments of the disclosed subject matter provide methods and systems to automatically identify preferred distributed programming content based on subscriber-specific profile information generated at least in part from a subscriber's viewing history of viewing broadcast television programs delivered via a television distribution system, automatically store information indicative of the identified preferred distributed programming content, and generate a personalized list of the identified preferred distributed programming content, the personalized list, displayed on initial activation of a video system, including at least one image of the identified preferred distributed programming content.

### TECHNICAL FIELD

The disclosed subject matter relates to the field of broadcast distribution and programming, and more particularly to systems and methods including personalized video program listing and targeted content advertising.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006, SBC Knowledge Ventures L.P. All Rights Reserved.

### BACKGROUND

Currently, television sets, set-top box video systems, cable television systems, satellite broadcasting systems, and other conventional video systems display the last channel watched when the systems are powered up. In many cases, viewers do not necessarily want to watch the last channel viewed. Conventional video systems also provide on-screen programming guides that list programming content available on various channels at various times. However, such on-screen programming guides are typically displayed as a grid of alphanumeric programming information that viewers must read and interpret. Further, such programming guides do not provide a useful and configurable level of personalization specific to a particular viewer. Though some conventional systems provide interactive program suggestion and systems for acquiring program selection history information, such as U.S. Pat. No. 6,425,128, conventional systems do not provide a personalized video program listing in the manner described and claimed herein.

Thus, a system and method for personalized video program listing and targeted content advertising is needed.

### BRIEF DESCRIPTION OF THE DRAWINGS

FIG. 1 is a flow diagram illustrating an example embodiment of the method for providing a personalized video program listing and targeted content advertising in accordance with the disclosed subject matter;

FIGS. 2, 3, and 4 illustrate an IPTV network in accordance with one example embodiment of the disclosed subject matter hereof;

FIGS. 5-6 illustrate example embodiments of the mosaic presentation.

FIGS. 7-8 illustrate various example embodiments of methods and systems for providing a personalized video program listing and targeted content advertising in accordance with the disclosed subject matter; and

FIG. 9 illustrates an example embodiment of a computing system in accordance with the disclosed subject matter.

FIGS. 10-17 illustrate various system implementations in accordance with example embodiments of the disclosed subject matter hereof;

### DETAILED DESCRIPTION

In the following detailed description, reference is made to the accompanying drawings that form a part hereof, and in which are shown by way of illustration, specific embodiments in which the disclosed subject matter can be practiced. It is understood that other embodiments may be utilized and structural changes may be made without departing from the scope of the disclosed subject matter.

As described further below, according to various example embodiments of the disclosed subject matter described herein, there is provided a system and method for personalized video program listing and targeted content advertising. The system includes a personalized video program listing generator operable to produce a personalized video program listing. Various embodiments are described below in connection with the figures provided herein.

Various embodiments disclosed herein describe a system and a method to personalize the initial programming content displayed to a viewer on initial activation of a video system at a particular time/day. In particular, 1) the channels that the viewer/subscriber is most likely to watch at that time are presented on the television (TV) screen and/or, 2) the programs most relevant to the subscriber's particular interest are presented on the TV screen in a convenient viewing format. Various embodiments disclosed herein also provide an effective advertising platform based on learned subscriber behavior to capitalize on the fast-growing broadcast and internet advertising markets.

Various embodiments disclosed herein significantly increase the probability that when a subscriber turns on the TV, the subscriber's favorite show is displayed on TV without the subscriber having to resort to channel surfing or viewing a program guide. When a TV is turned on, conventional systems provide a subscriber with the last-viewed channel regardless of when the channel was watched. In contrast, various embodiments disclosed herein provide the subscriber with a personalized list of preferred distributed programming content (e.g. a rank-ordered list of channels), which could be arranged and displayed as a tiled arrangement of thumbnail views of programming content from the subscriber-specific set of channels, which the subscriber is most likely to prefer watching at the time TV viewing is initiated. The display of images related to preferred distributed programming content is beneficial for the viewer/subscriber; because the viewer/subscriber can immediately begin viewing preferred channels without having to read a programming guide. This creates a better user/viewer experience.

One factor in various embodiments described herein is that likely subscriber viewing preferences are related to the time/day the viewing is initiated. For example, a subscriber might have watched “Daily Show with Jon Stewart” on Comedy Central at 11 pm the previous night. When the subscriber turns on the TV on the following evening at 8 pm, the probability is low that the subscriber would like to watch Comedy Central (or the same channel) at that time. The probability is very small because the subscriber's chosen program on the previous evening, “Daily Show with Jon Stewart”, is not going to be aired until 11 pm on the following evening. Thus, a subscriber's viewing preferences likely vary depending on the time/day the viewing in initiated.

In a manner described in more detail below, various embodiments disclosed herein display a set of the most likely preferred program channel content, as preferred by a particular subscriber at a particular time/day. These most likely preferred channels, denoted Top X channels, (e.g., X=1, 2, 4, etc, channels) represent the video content the particular subscriber is most likely to prefer at the particular time/day based on subscriber-specific information collected automatically by the system. Various embodiments collect subscriber-specific information including a channel/content viewing history for a particular subscriber. Various embodiments can also obtain automatically generated or explicitly entered subscriber profile information, such as demographic information, geographical information, and the like, which is associated with a specific subscriber. In one embodiment, this subscriber-specific information is collected periodically in real time, e.g., on a 30-minute interval. Based on this subscriber-specific information, various embodiments deduce the Top X channels that the subscriber is most interested in at each time interval based on the subscriber's viewing history and other subscriber viewing profile information. Then, various embodiments display the Top X channels on a TV screen as a rank-ordered list of channels, which could be arranged and displayed as a tiled arrangement of thumbnail views of programming content from the subscriber-specific Top X set of channels. In one embodiment, the tiled arrangement of thumbnail views of programming content can be displayed as different picture-in-picture (PIP) streams, which are laid out as 1×2, 2×2, or m×n in general, “mosaic” pieces. The mosaic screen can be automatically updated based on the subscriber's interest and depending on the time/day when the TV activated. In one embodiment, the most relevant (e.g. most likely subscriber preferred) channel is laid out first and highlighted on the TV screen. Additionally, such mosaic screens on a particular TV screen can be presented based on the identity of a logged-in subscriber. Thus, the capture of subscriber-specific information as described above can be based on the identity of a logged in subscriber. In this manner, various embodiments can present a Top X set of likely preferred content in a mosaic presentation on a TV screen for a specific logged-in subscriber. A different logged-in subscriber might therefore see a different Top X set of likely preferred content in a mosaic presentation on the same TV screen. Various embodiments therefore provide a highly personalized set of preferred content viewing options.

Various embodiments disclosed herein can substantially increase subscriber satisfaction and differentiate video distribution and programming services competing with cable, satellite, or IPTV services by significantly increasing the probability that when a subscriber turns on the TV, the subscriber's favorite show(s) is automatically displayed on the TV without the subscriber having to resort to channel surfing or program guide manipulation.

Additionally, various embodiments disclosed herein provide an effective advertising platform to capitalize on the fast-growing broadcast and internet advertising markets to generate a new revenue stream. In a manner described in more detail below, various embodiments can use the subscriber-specific information captured as described above to generate a set of targeted advertisements particularly suited to a particular subscriber based on the subscriber-specific information. The targeted advertising can be displayed as part of the mosaic presentation as described above. As such, on initial activation of a TV set, the subscriber is presented with a mosaic presentation showing the subscriber the Top X set of likely preferred content and a set of targeted advertisements specifically suited to the particular subscriber. Further, the mosaic presentation can include video-on-demand (VoD) channels, pay-per-view channels, or special programming likely to be of interest to a particular subscriber based on the subscriber-specific information. The subscriber-targeted advertisements would typically be sponsored ads provided by a merchant or advertiser. The merchant or advertiser sponsors bid for the placement of their advertising content in the mosaic presentation on the TV set. In most cases, the higher the bid, the higher the rank in the mosaic presentation and the better positioned the ad will be in the mosaic presentation. The merchant or advertiser sponsors or the video content providers/distributors can be charged fees and/or a commission for each visit a subscriber makes to a merchant location as a result of the targeted advertising.

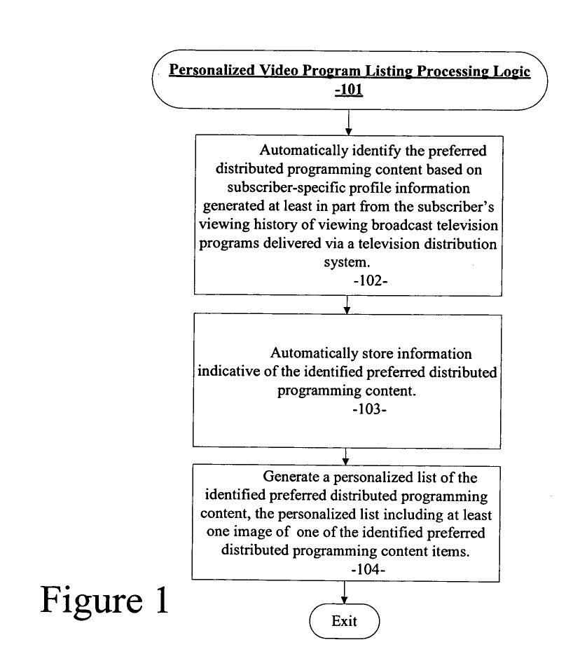

Referring to FIG. 1, a flow diagram illustrates a set of operations in an example embodiment. In processing block 102, various embodiments automatically identify preferred distributed programming content based on subscriber-specific profile information generated at least in part from the subscriber's viewing history of viewing broadcast television programs delivered via a television distribution system. In processing block 103, various embodiments automatically store information indicative of the identified preferred distributed programming content. In processing block 104, various embodiments generate a personalized list of the identified preferred distributed programming content, the personalized list including at least one image of one of the identified preferred distributed programming content items.

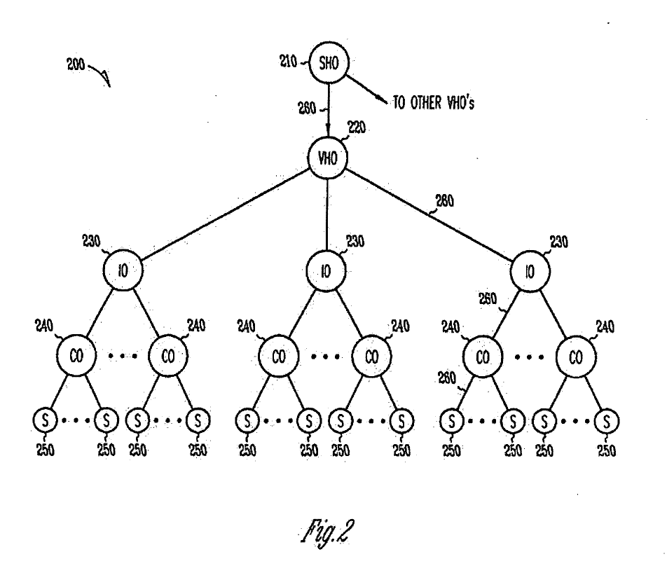

Referring now to FIGS. 2, 3, and 4, there is illustrated one example embodiment of a television distribution system or network 200, using IPTV technology in this example but not limited thereto, adapted to provide, among other things, the personalized video program listing and targeted content advertising features of the disclosed subject matter. As shown in FIG. 2, the network 200 may include a super hub office (SHO) 210 for acquisition and encoding of video content, one or more video hub offices (VHO) 220 in each demographic market area (DMA), one or more intermediate offices (IO) 230, one or more central offices (CO) 240 located in each metropolitan area, and, finally, the subscribers (S) 250, who may be located in single or multiple dwelling units. In one example embodiment, the network 200 may be connected through a plurality of high speed communication links 260 using physical transport layers such as fiber, cable, twisted pair, air, or other media.

In one example embodiment of the IPTV video delivery system, the SHO 210 distributes content to one or more VHOs 220, which may be spread across a wide geographic territory, such as an entire country. The SHO 210 may, for example, be in a central location for acquisition and aggregation of national-level broadcast TV (or linear) programming. A redundant SHO 210 may be provided for backup in case of failure. The SHO 210 may also provide the central point of on-demand content acquisition and insertion into the IPTV network. Linear programming may be received at the SHO 210 via satellite and processed for delivery to the VHO 220. On demand content may be received from various sources and processed/encoded to codec and bit-rate requirements for the communication network for transmission to the VHO 220 over the high speed communication links. The VHOs 220 are the video distribution points within each demographic market area (DMA) or geographic region.

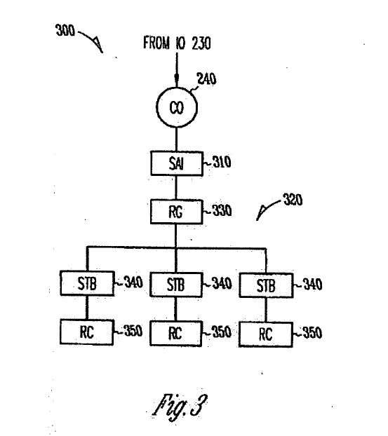

Referring now to FIG. 3, there is illustrated, in more detail, an example network architecture 300 between the CO 240 and the subscriber 250. A serving area interface (SAI) 310 may be connected to the CO 240. SAI 310 may, for example, be located in a weather-proof enclosure proximate the subscriber 250 premises, and may include fiber-to-the-node (FTTN) equipment. FTTN equipment may also be located in the CO 240. Customer premise equipment (CPE) 320 includes, for example, a network interface device (NID) and a residential gateway (RG) 330, with a built-in very-high-bit-rate digital subscriber loop (VDSL) modem or optical network termination (ONT). In either case the RG 330 may be connected to the rest of the home set top boxes (STB) 340 via an internal network such as an Ethernet. Each STB 340 has an associated remote control (RC) 350 which provides data entry to the STB 340 to control the IPTV selections from the IPTV data streams.

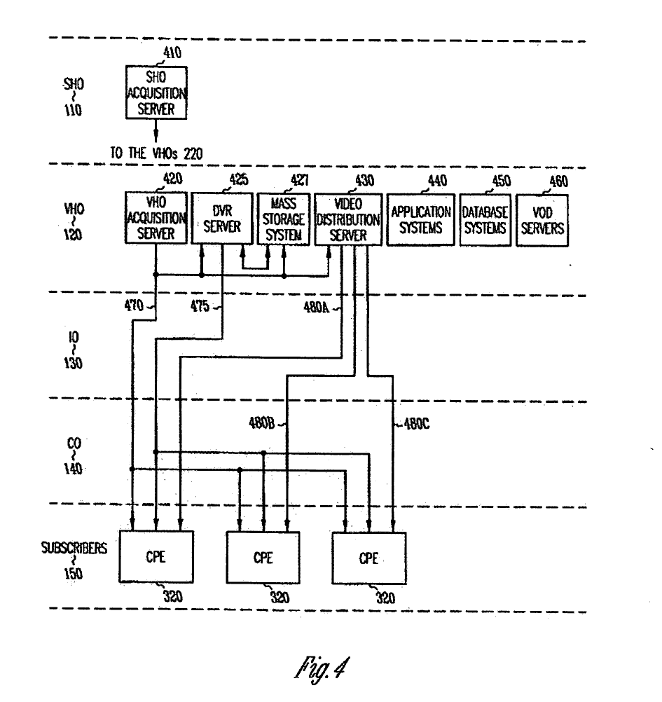

Referring now to FIG. 4, which illustrates one example embodiment of a configuration according to the disclosed subject matter, a SHO acquisition server 410 may be used to acquire national content that may be distributed towards the VHO 220. In an alternative embodiment, live television content may be acquired using an acquisition server in the VHO 220. In this configuration, the VHO 220 may include a live television acquisition server 420 and a video distribution server 430, which forward the live television and/or other content toward the subscribers 250 through the intermediate offices (IOs) 230 and the central office (CO) 240. A VHO 220 may also include application systems 440, regional subscriber 250 database systems 450, and VOD servers 460. The COs 240 are connected to the IOs 230 to further distribute traffic towards the subscribers 250. Traffic may reach the subscribers 250 at least partially via either fiber to the node (FTTN) or fiber to the premises (FTTP), or by other types of transmission medium.

As also illustrated in FIG. 4, acquisition server 420 may distribute a plurality of live television programs, each typically associated with a television “channel,” using a multicast IP protocol data stream 470 through the IOs 230 and COs 240 to the subscribers 250. The routers, switches, and other network elements that would normally be present in the IOs 230 and COs 240 are not shown in FIG. 4 in order to simplify the drawing. The number of programs or channels sent in the multicast stream may, without limitation, range up to 800 channels or more using present technology, with it being understood that advances in technology may allow many more channels to be sent. The multicast protocol allows for efficient distribution of these signals to a large number of end subscribers 250. In addition, the video distribution server 430 receives the multicast data stream 470, and distributes selected ones of the live television signals, extracted from the stream 470, using a unicast data stream 480a, 480b, or 480c, to specific subscribers 250. In this embodiment, video distribution server 430 may provide a unicast stream, for example in burst mode, of a specific live television channel to any of the subscribers 250 served by the VHO 220. The burst mode instant channel change data stream can be discontinued once the subscriber's 250 system is loaded with enough TV program data so that the multicast stream can “catch up” and take over supplying the program data stream in the multicast mode for more extended term viewing by the subscriber 250.

Also provided in the VHO 220, or alternatively at another distribution point in the IPTV network such as the SHO 210, IO 230, or CO 240, is an additional digital video recorder (DVR) server 425 that acquires live television programming, records the programming/channels in digital form, and distributes the recorded content to subscribers 250 using a unicast data stream in the same manner as server 430. DVR server 425 may be connected to, in one example embodiment, one or more mass storage devices or systems 427, such as magnetic disk drives or optical recording systems. In addition, DVR server 425 includes software 426 to support interaction with subscribers 250 through STB 340. For example, subscribers 250 can, interact with the DVR server 425 using a remote control 350 and an STB 340 to request programming be saved, view saved programming on their own list of saved content, and request delivery of the saved content to them from DVR server 425. Alternatively, in another embodiment, the functions described for DVR server 425 may be performed by a single acquisition server such as server 420 or VOD server 460, and DVR server 425 can be eliminated in whole or in part. The subscribers 250 may request content recorded on DVR server 425, which is delivered, in one example embodiment, with unicast data streams 490A, 490B, or 490C.

According to one embodiment, access to regularly scheduled programming on the television channels, or alternatively access to programming recorded under the control of DVR server 425, may be controlled by an STB 340 in the subscriber 250's premises. Thus, in one example embodiment, each subscriber 250 receives live television programs from the video acquisition server 420 based on IP-based multicasting services, while the video distribution servers 430 are used to provide subscribers 250 “instant” channel change and recover video packet losses to maintain acceptable quality of service. Further, the DVR server 425 provides recorded television programming upon demand by subscribers 250 as more fully described herein.

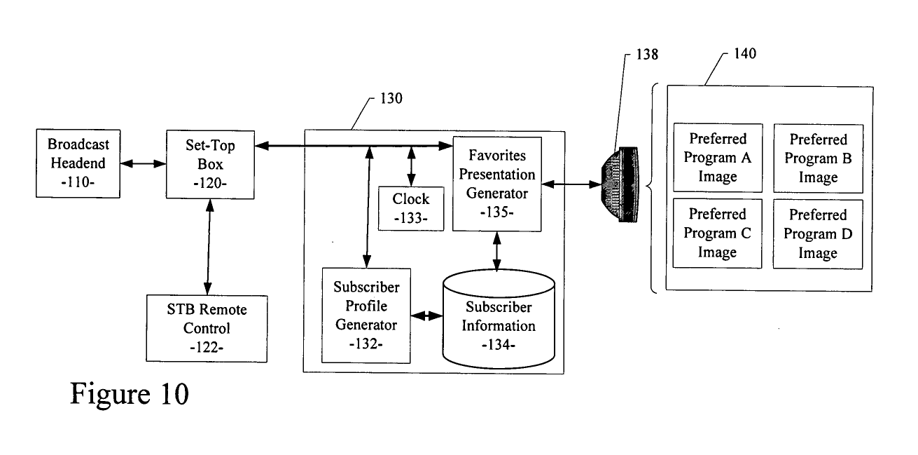

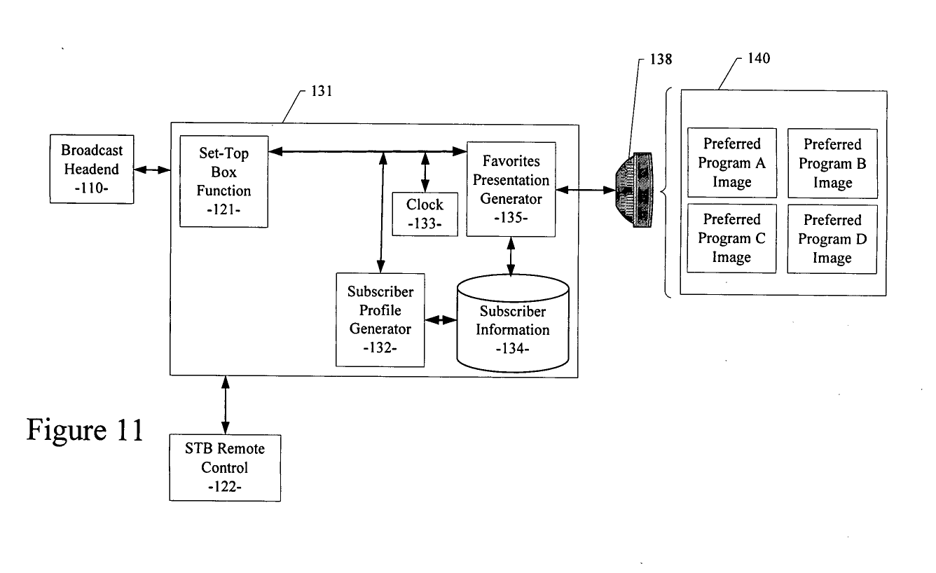

According to one example embodiment, TV shows may be monitored on the subscriber 250 side, for example in the STB 340. On the subscriber 250 side, the STB 340 receives subscriber 250-initiated control commands from, for example the RC 350, such as channel changes, video-on-demand program ordering, and other control information. This information can be used to collect accurate subscriber-specific information representing the viewing history for a particular subscriber 250 based on TV viewing information accessible in each individual subscriber's 250 STB 340. Alternatively, if such subscriber-specific information is not available from the STB 340, subscriber 250 viewing information can be obtained from the RG 330 based on IP multicast information obtained from the RG 330. In another embodiment, the subscriber 250 viewing information may be obtained from the VHO 220 based on, for example, channel-change requests sent from the STB 340 to the video distribution server 430 in VHO 220. In another embodiment, the subscriber 250 viewing information may be obtained from a subscriber profile maintained as part of the subscriber's account with the video distribution or programming service. Further, a subscriber viewing profile can be explicitly provided or updated by the subscriber via a TV menu interaction or a web-based user interface. A subscriber viewing profile can also be automatically provided or updated based on a subscriber's viewing history and behavior, demographic information, geographic information, transaction history, and the like. As a result, subscriber 250 channel-change and profile information can be collected from the STB 340, the video distribution server 430, and/or other sources and stored in an accessible location for the generation of a personalized list of preferred video content. Collection of subscriber 250 program viewing and profile information may be orchestrated by software in STB 240, software in a separate personalized video program list generator 130 (shown in FIG. 10), software in DVR server 425, or by other software in various systems and components of the TV distribution system as shown by example in FIGS. 11-17.

Although the system and method as described above is shown in an example form implemented in an IPTV distribution system, the disclosed system and method may, in another example embodiment, may be implemented in a cable television system, in a broadcast television system, in a satellite distribution system, in a wireless distribution system, or in other distribution systems.

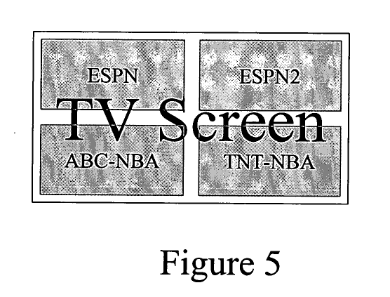

Referring now to FIGS. 10-17, there are illustrated several example implementations of various embodiments. In FIG. 10, an embodiment of a personalized video program list generator 130 is illustrated. In this example, personalized video program list generator 130 is coupled between set-top box 120 and a television monitor 138. Set-top box 120 represents a conventional set-top box that receives programming content from a broadcast head end 110. Broadcast head end 110 can be a cable television programming provider, a satellite television programming provider, a wireless video source, or other video distribution system. Broadcast head end 110 provides a set of video programming content channels to set-top box 120. Using a conventional set-top box remote control device 122, a subscriber at a subscriber location can select one of the programming channels provided to set-top box 120 by broadcast head end 110 for viewing on TV monitor 138. In one embodiment, personalized video program list generator 130 receives programming content from set-top box 120 and routes the programming content to TV monitor 138. In addition, generator 130 includes a subscriber profile generator 132 that monitors subscriber channel selections made through set-top box 120. In this matter, subscriber profile generator 132 can capture subscriber viewing history, which can be stored in a data repository 134 used for the storage of subscriber specific information. In addition, generator 130 can include a clock 133 with which subscriber profile generator 132 can correlate subscriber channel selections with the time and day when the channel selections were made. This time correlated subscriber channel selection information can also be stored in data repository 134. The subscriber specific information stored in subscriber information data repository 134 can be used by a favorites presentation generator 135. Favorites presentation generator 135 can determine from the subscriber specific information in data repository 134, which of a large set of available programming channels would likely be a configurable set of preferred channels favored by a particular subscriber at a particular time/day when viewing by the subscriber is initiated. Using this information, favorites presentation generator 135 can create a mosaic presentation of video images 140 corresponding to the top one or more channels likely to be preferred by a particular subscriber at a particular time/day. An example of such a mosaic presentation of subscriber preferred channels 140 is illustrated in FIG. 5.

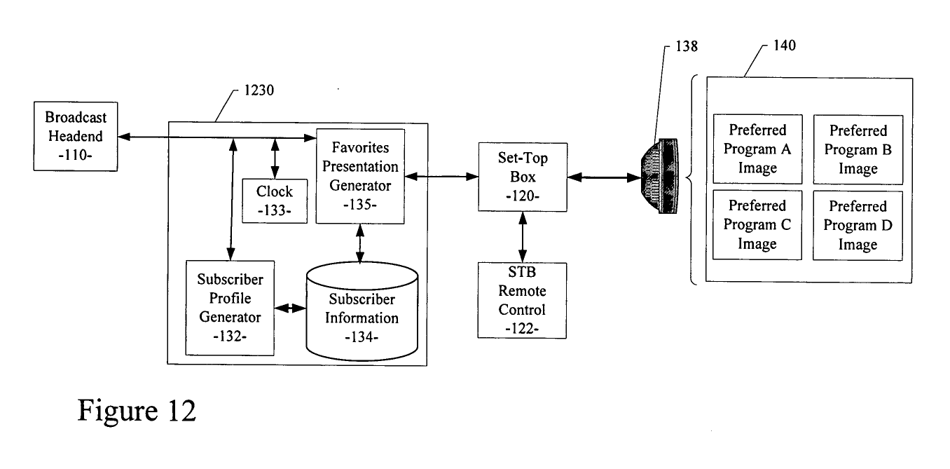

Although personalized video program list generator 130 is illustrated in the embodiment shown in FIG. 10 as separate from set-top box 120, the functionality of personalized video program list generator 130 can also be built into a set-top box. Such an alternative embodiment is illustrated in FIG. 11. Referring to FIG. 11, personalized video program list generator and set-top box 131 is illustrated. In this embodiment, conventional set-top box functionality 121 is included with the personalized video program list generator functionality described above in connection with FIG. 10. As described above in connection with FIG. 10, personalized video program list generator and set-top box 131 uses subscriber specific information captured by subscriber profile generator 132, and generates a mosaic presentation of video images 140 corresponding to the top one or more channels likely to be preferred by a particular subscriber at a particular time/day. FIG. 12 illustrates another alternative embodiment of the personalized video program list generator 1230. In this example, personalized video program list generator 1230 is coupled between the broadcast headend 110 and set-top box 120. As described above, personalized video program list generator 1230 uses subscriber specific information captured by subscriber profile generator 132, and generates a mosaic presentation of video images 140 corresponding to the top one or more channels likely to be preferred by a particular subscriber at a particular time/day.

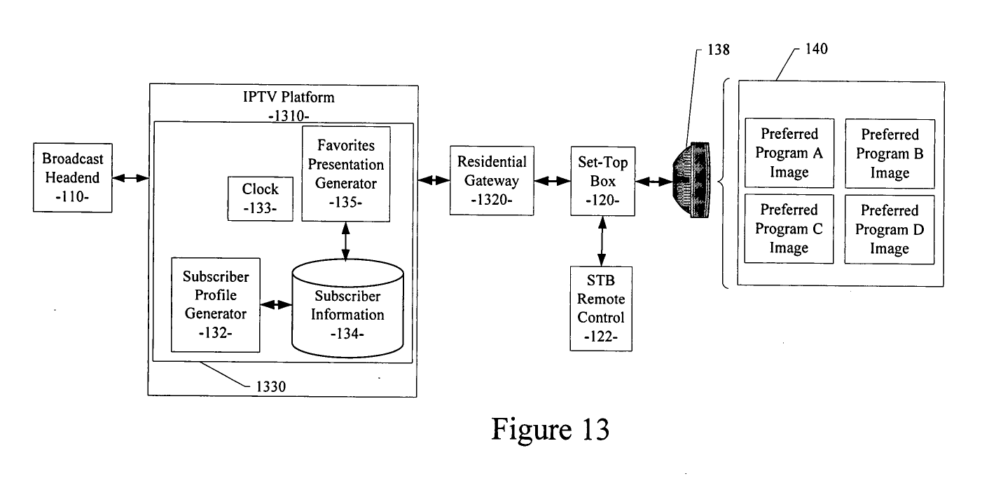

FIG. 13 illustrates another alternative embodiment of the personalized video program list generator 1330. In this example, personalized video program list generator 1330 is part of an IPTV platform 1310 (described above) and coupled between the broadcast headend 110 and a residential gateway 1320, which is coupled to set-top box 120. As described above, personalized video program list generator 1330 uses subscriber specific information captured by subscriber profile generator 132, and generates a mosaic presentation of video images 140 corresponding to the top one or more channels likely to be preferred by a particular subscriber at a particular time/day.

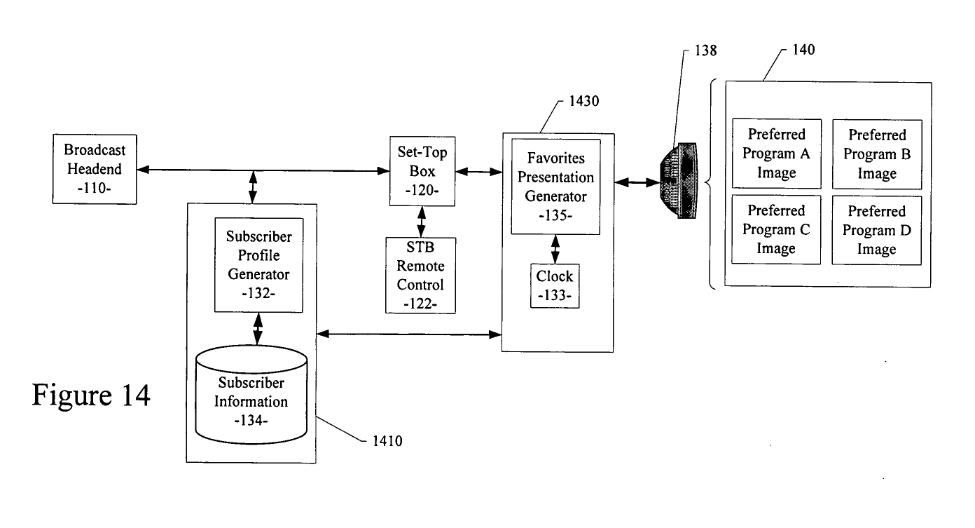

FIG. 14 illustrates another alternative embodiment of the personalized video program list generator. In this example, personalized video program list generator functionality is split into a subscriber profile engine 1410 and a favorites presentation engine 1430. In this embodiment, the subscriber profile engine 1410 is coupled between the broadcast headend 110 and set-top box 120. The favorites presentation engine 1430 is coupled between set-top box 120 and TV monitor 138. As described above, the personalized video program list generator (represented by the combination of subscriber profile engine 1410 and favorites presentation engine 1430) uses subscriber specific information captured by subscriber profile generator 132, and generates a mosaic presentation of video images 140 corresponding to the top one or more channels likely to be preferred by a particular subscriber at a particular time/day.

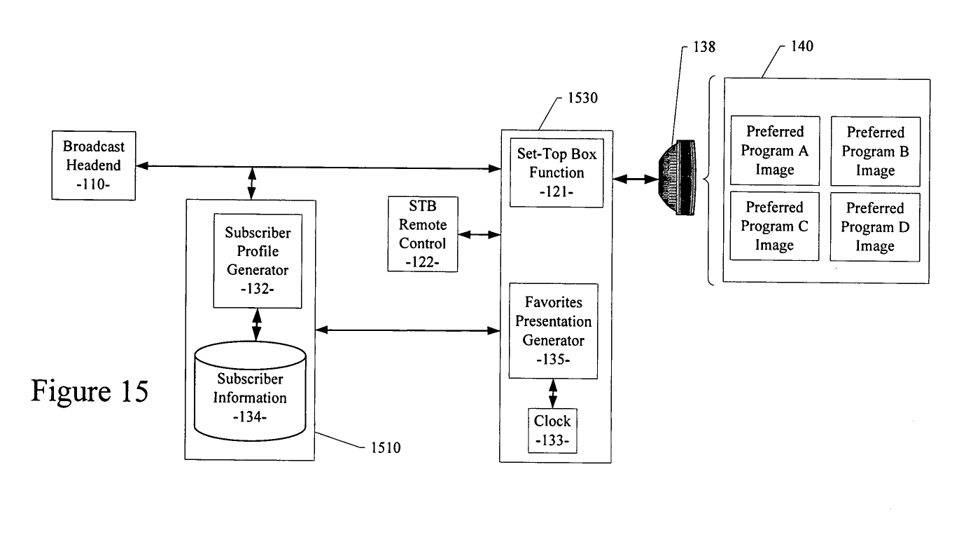

FIG. 15 illustrates another alternative embodiment of the personalized video program list generator. In this example, personalized video program list generator functionality is split into a subscriber profile engine 1510 and a favorites presentation engine and set-top box 1530. In this embodiment, the subscriber profile engine 1510 is coupled between the broadcast headend 110 and set-top box function 121. The favorites presentation engine and set-top box 1530 is coupled between broadcast headend 110 and TV monitor 138. As described above, the personalized video program list generator (represented by the combination of subscriber profile engine 1510 and favorites presentation engine and set-top box 1530) uses subscriber specific information captured by subscriber profile generator 132, and generates a mosaic presentation of video images 140 corresponding to the top one or more channels likely to be preferred by a particular subscriber at a particular time/day.

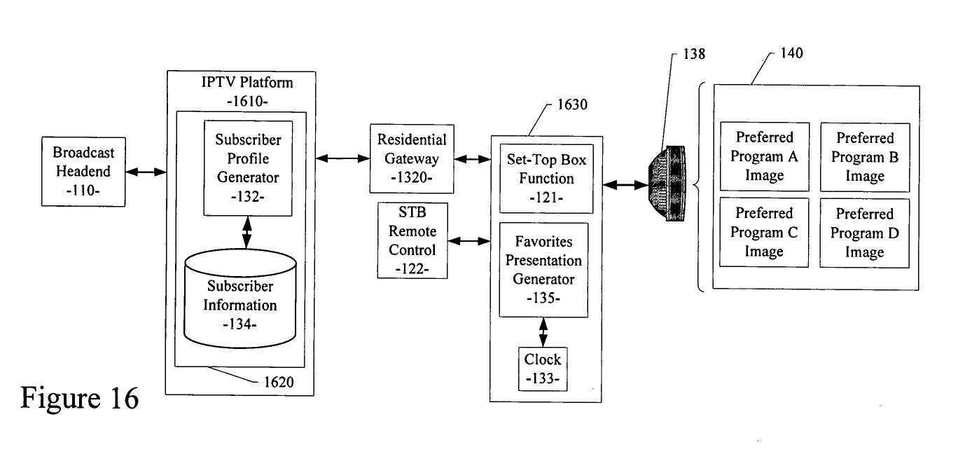

FIG. 16 illustrates another alternative embodiment of the personalized video program list generator. In this example, personalized video program list generator functionality is split into a subscriber profile engine 1620 and a favorites presentation engine and set-top box 1630. In this example, the subscriber profile engine 1620 is part of an IPTV platform 1610 (described above) and coupled between the broadcast headend 110 and a residential gateway 1320, which is coupled to set-top box function 121. The favorites presentation engine and set-top box 1630 is coupled between the residential gateway 1320 and TV monitor 138. As described above, the personalized video program list generator (represented by the combination of subscriber profile engine 1620 and favorites presentation engine and set-top box 1630) uses subscriber specific information captured by subscriber profile generator 132, and generates a mosaic presentation of video images 140 corresponding to the top one or more channels likely to be preferred by a particular subscriber at a particular time/day.

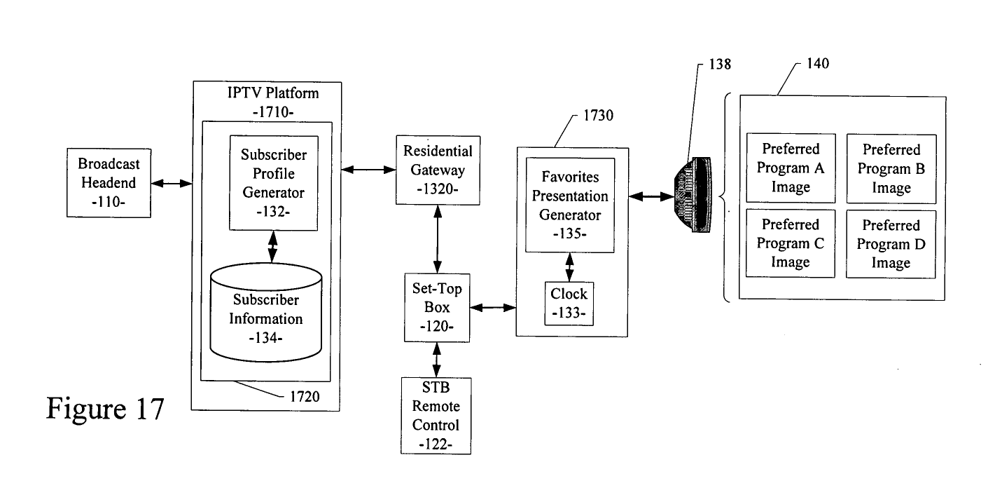

FIG. 17 illustrates another alternative embodiment of the personalized video program list generator. In this example, personalized video program list generator functionality is split into a subscriber profile engine 1720 and a favorites presentation engine 1730. In this example, the subscriber profile engine 1720 is part of an IPTV platform 1710 (described above) and coupled between the broadcast headend 110 and a residential gateway 1320, which is coupled to set-top box 120. The favorites presentation engine 1730 is coupled between the set top box 120 and TV monitor 138. As described above, the personalized video program list generator (represented by the combination of subscriber profile engine 1720 and favorites presentation engine 1730) uses subscriber specific information captured by subscriber profile generator 132, and generates a mosaic presentation of video images 140 corresponding to the top one or more channels likely to be preferred by a particular subscriber at a particular time/day.

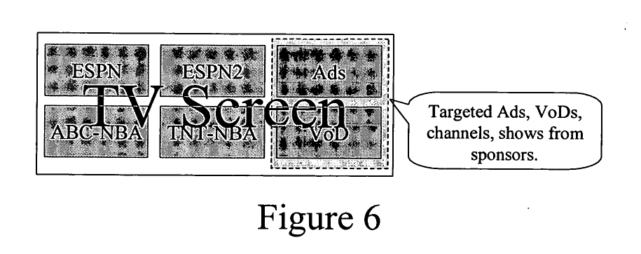

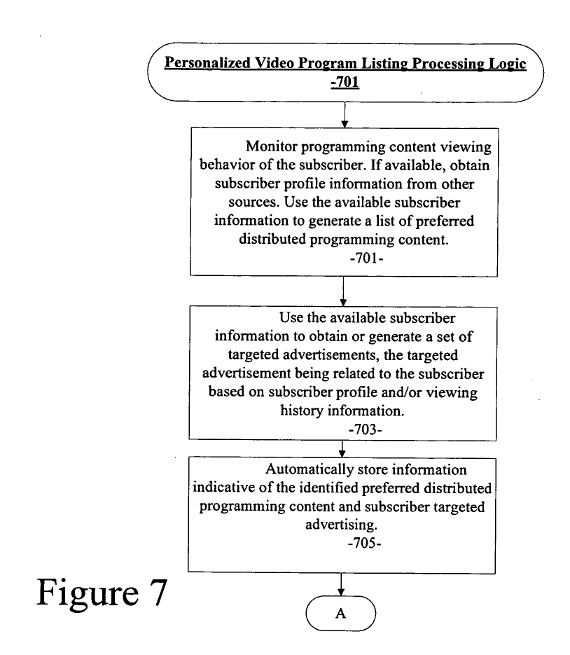

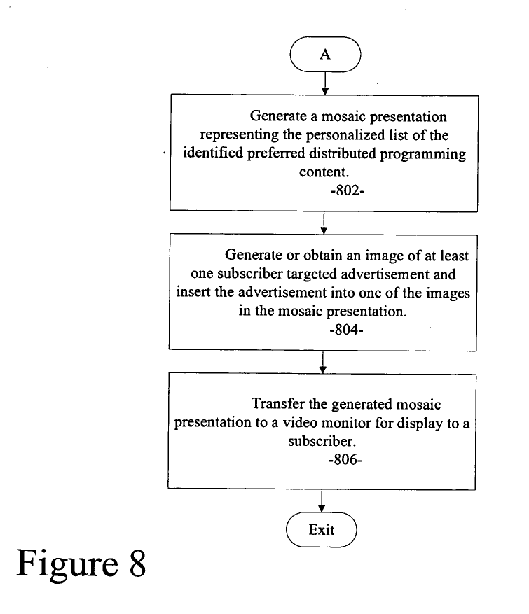

Referring to FIGS. 7-8, flow diagrams illustrate a set of operations in an example embodiment. In processing block 701, various embodiments automatically monitor programming content viewing behavior of the subscriber. If available, subscriber profile information is obtained from other sources. In processing block 701, various embodiments use the available subscriber information to generate a list of preferred distributed programming content. In processing block 703, various embodiments also use the available subscriber information to obtain or generate a set of targeted advertisements, the targeted advertisement being related to the subscriber based on subscriber profile and/or viewing history information. In processing block 705, various embodiments automatically store information indicative of the identified preferred distributed programming content and subscriber targeted advertising. Processing then continues at the bubble A shown in FIG. 8. Referring to FIG. 8, in processing block 802, various embodiments generate a mosaic presentation representing the personalized list of the identified preferred distributed programming content. Again, an example of such a mosaic presentation of an embodiment is shown in FIG. 5. In processing block 804, various embodiments generate or obtain an image of at least one subscriber targeted advertisement and insert the advertisement into one of the images in the mosaic presentation. An example of such a mosaic presentation with targeted advertising of an embodiment is shown in FIG. 6. In processing block 806, various embodiments transfer the generated mosaic presentation to a video monitor for display to a subscriber.

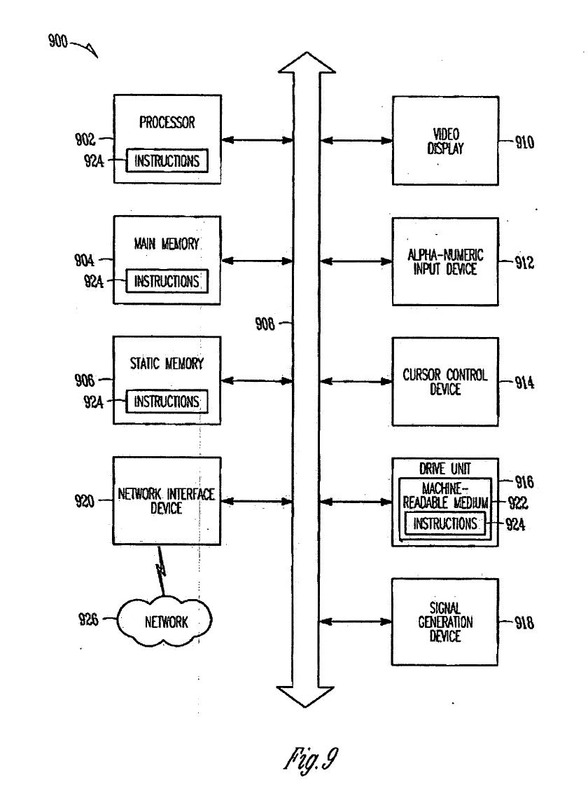

Referring now to FIG. 9, a diagrammatic representation of a machine is shown in the example form of a computer system 900 of a type sufficient for use in any of the example embodiments set forth herein. System 900 may include a set of instructions for causing the machine to perform any one or more of the methodologies discussed herein, that may be executed. In alternative embodiments, the machine operates as a standalone device or may be connected (e.g., networked) to other machines. In a networked deployment, the machine may operate in the capacity of a server, a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904, and/or within the processor 902, during execution thereof by the computer system 900. The main memory 904 and the processor 902 also constituting machine-readable media.

The software 924 may further be transmitted or received over a network 926 via the network interface device 920 utilizing any one of a number of well-known transfer protocols, for example, the hyper text transfer protocol (HTTP). While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the disclosed subject matter, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

Although the present specification describes components and functions implemented in the embodiments with reference to particular standards and protocols, the disclosed subject matter may be not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

Thus, system and method for personalized video program listing and targeted content advertising is disclosed. While the example embodiments herein are generally illustrated in the environment of an IPTV system, in an alternative embodiment a cable distribution system or satellite distribution system may be used instead. Such a system may or may not use IPTV methodologies. Other available distribution techniques may be used instead, such as frequency modulation or each channel in a television frequency band, or time division or orthogonal frequency division multiplexing, for example only and not by way of limitation. Further, the IPTV may be delivered over-the-air using, for example, broadband wireless telecommunications techniques.

Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A method comprising:
automatically identifying preferred distributed programming content based on subscriber-specific profile information generated at least in part from a subscriber's viewing history of viewing broadcast television programs delivered via a television distribution system;
automatically storing information indicative of the identified preferred distributed programming content; and
generating a personalized list of the identified preferred distributed programming content, the personalized list, displayed on initial activation of a video system, including at least one image of the identified preferred distributed programming content.

2. A method according to claim 1 wherein the identified preferred distributed programming content is automatically stored in at least one set top box located in a subscriber location.

3. A method according to claim 1 wherein the identified preferred distributed programming content is automatically stored upstream from a subscriber's location in the television distribution system.

4. A method according to claim 1 wherein the identified preferred distributed programming content is based in part on one or more categories selected from the group: subscriber demographic factors, geographical location of subscribers, time of day, time of week, or type of program.

5. A method according to claim 1 further including monitoring the viewing of television programs by one or more subscribers in the television distribution system in order to determine the identified preferred distributed programming content.

6. A method according to claim 1 further including delivering television programs to subscribers using an Internet protocol television (IPTV) distribution system.

7. A method according to claim 1 further including delivering television programs to subscribers using one or more distribution systems selected from the group: a cable television distribution system, satellite television distribution system, wireless television distribution system.

8. A method according to claim 1 wherein the identified preferred distributed programming content is based in part on an identity of a logged in subscriber.

9. A method according to claim 1 further including generating a mosaic presentation of programming images corresponding to the identified preferred distributed programming content.

10. A method according to claim 1 further including generating a thumbnail image of programming corresponding to the identified preferred distributed programming content.

11. A method according to claim 1 further including generating a targeted advertisement, the targeted advertisement being related to a subscriber based on the subscriber-specific profile information.

12. An article of manufacture comprising at least one machine readable storage medium having one or more computer programs stored thereon and operable on one or more computing systems to: automatically identify preferred distributed programming content based on subscriber-specific profile information generated at least in part from a subscriber's viewing history of viewing broadcast television programs delivered via a television distribution system, automatically store information indicative of the identified preferred distributed programming content, and generate a personalized list of the identified preferred distributed programming content, the personalized list, displayed on initial activation of a video system, including at least one image of the identified preferred distributed programming content.

13. An article of manufacture according to claim 12 wherein the identified preferred distributed programming content is automatically stored in at least one set top box located in a subscriber location.

14. An article of manufacture according to claim 12 wherein the identified preferred distributed programming content is automatically stored upstream from a subscriber's location in the television distribution system.

15. An article of manufacture according to claim 12 wherein the identified preferred distributed programming content is based in part on one or more categories selected from the group: subscriber demographic factors, geographical location of subscribers, time of day, time of week, or type of program.

16. An article of manufacture according to claim 12 being further operable to monitor the viewing of television programs by one or more subscribers in the television distribution system in order to determine the identified preferred distributed programming content.

17. An article of manufacture according to claim 12 being further operable to deliver television programs to subscribers using an Internet protocol television (IPTV) distribution system.

18. An article of manufacture according to claim 12 being further operable to deliver television programs to subscribers using one or more distribution systems selected from the group: a cable television distribution system, satellite television distribution system, wireless television distribution system.

19. An article of manufacture according to claim 12 wherein the identified preferred distributed programming content is based in part on an identity of a logged in subscriber.

20. An article of manufacture according to claim 12 being further operable to generate a mosaic presentation of programming images corresponding to the identified preferred distributed programming content.

21. An article of manufacture according to claim 12 being further operable to generate a thumbnail image of programming corresponding to the identified preferred distributed programming content.

22. An article of manufacture according to claim 12 being further operable to generate a targeted advertisement, the targeted advertisement being related to a subscriber based on the subscriber-specific profile information.

23. A system comprising:
a television distribution network;
a subscriber profile generator coupled to the television distribution network to automatically identify preferred distributed programming content based on subscriber-specific profile information generated at least in part from a subscriber's viewing history of viewing broadcast television programs delivered via the television distribution network, the subscriber profile generator further to automatically store information indicative of the identified preferred distributed programming content, and
a favorites presentation generator to generate a personalized list of the identified preferred distributed programming content, the personalized list, displayed on initial activation of a video system, including at least one image of the identified preferred distributed programming content.

24. A system according to claim 23 wherein the identified preferred distributed programming content is automatically stored upstream from a subscriber's location in the television distribution system.

25. A system according to claim 23 wherein the favorites presentation generator being further operable to generate a mosaic presentation of programming images corresponding to the identified preferred distributed programming content.

26. A system according to claim 25 wherein at least one of the images in the mosaic presentation is a targeted advertisement, the targeted advertisement being related to a subscriber based on subscriber profile information.

27. A system comprising:
a television distribution network;
a subscriber profile generator coupled to the television distribution network to automatically identify preferred distributed programming content based on subscriber-specific profile information generated at least in part from a subscriber's viewing history of viewing broadcast television programs delivered via the television distribution network, the subscriber profile generator further to automatically store information indicative of the identified preferred distributed programming content; and
a favorites presentation generator to generate, on initial activation of a video system, a mosaic presentation of programming images corresponding to the identified preferred distributed programming content.

28. A system according to claim 27 wherein at least one of the images in the mosaic presentation is a targeted advertisement, the targeted advertisement being related to a subscriber based on subscriber profile information.

29. A system comprising:
a television distribution network;
a subscriber profile generator coupled to the television distribution network to automatically identify preferred distributed programming content based on subscriber-specific profile information generated at least in part from a subscriber's viewing history of viewing broadcast television programs delivered via the television distribution network, the subscriber profile generator further to automatically store information indicative of the identified preferred distributed programming content, and
a favorites presentation generator to generate, on initial activation of a video system, a personalized list of the identified preferred distributed programming content with a targeted advertisement, the targeted advertisement being related to a subscriber based on subscriber profile information.

30. A system according to claim 29 wherein the favorites presentation generator being further operable to generate a mosaic presentation of programming images corresponding to the identified preferred distributed programming content, at least one of the images in the mosaic presentation being the targeted advertisement.

31. A system according to claim 29 wherein the favorites presentation generator being further operable to rank placement of the targeted advertisement in the mosaic presentation based on a merchant/advertiser bid.

32. A system comprising:
a television distribution network;
a subscriber profile generator coupled to the television distribution network to automatically identify preferred distributed programming content based on subscriber-specific profile information generated at least in part from a subscriber's viewing history of viewing broadcast television programs delivered via the television distribution network, the subscriber profile generator further to automatically store information indicative of the identified preferred distributed programming content;
a favorites presentation generator to generate a mosaic presentation of programming images corresponding to the identified preferred distributed programming content; and
a set-top box coupled to the favorites presentation generator to display the mosaic presentation.

33. A system according to claim 32 wherein the favorites presentation generator being further operable to generate a targeted advertisement, the targeted advertisement being related to a subscriber based on subscriber profile information.
